(19) United States
(12) Patent Application Publication
(10) Pub. No.: US 2018/0206053 A1
(43) Pub. Date: Jul. 19, 2018

(54) System and Method for Spatial Audio Precomputation and Playback

(71) Applicant: Jason Caulkins, Issaquah, WA (US)

(72) Inventor: Jason Caulkins, Issaquah, WA (US)

(21) Appl. No.: 15/406,030

(22) Filed: Jan. 13, 2017

(51) Int. Cl. H04S 7/00

(52) U.S. Cl. CPC H04S 7/303; H04S 2420/01; H04S 2400/11

(57) ABSTRACT

A system and method for optimizing spatial audio in virtual 3D spaces installed on a computing appliance is provided, comprising of steps, prior to runtime, automatically or manually laying out a grid of nodes in the 3D space, running an acoustic simulation at each node, recording the results after the simulated sound has interacted with the virtual environment, then, based on the simulation input and output, creating a unique transfer function for each node and node pair, recording the transfer functions to an indexed matrix, and, at runtime, utilizing the transfer function matrix and the relative distances between the audio source(s), the node(s), and the listener(s) to create a singular, instantaneous, weighted transfer function which is then applied to the audio stream to create more realistic audio experience for the listener.

### CROSS-REFERENCE TO RELATED APPLICATIONS

N/A

### BACKGROUND OF THE INVENTION

### 1. Field of the Invention

The present invention is in the field of general-purpose computers, and pertains particularly to precomputing spatial sound in a digital environment, such as a video game, virtual reality, augmented reality or mixed reality, then using the precomputed results to create a simplified approach to playing back realistic spatial audio at runtime.

### 2. Description of Related Art

Computer systems have advanced considerably over time. However, with the rapid growth of increasingly demanding applications, compute cycles are still at a premium, especially at runtime, due to the conflicting requirements for ultra-low latency and ultra-high fidelity. These issues are critical as augmented and virtual reality become more mainstream, especially while additionally considering cost, portability, and power requirements.

With system compute resources at a premium, the well-known but complex calculations required to dynamically simulate life-like spatial audio in a virtualized landscape have proven to be too computationally expensive to calculate live at runtime.

For optimal performance, computer programs and applications have relied on various simplifications to approximate spatial sound in real time. While better than nothing, they fall short in dynamically creating an accurate representation of spatial audio. What is needed is a method to enable the precomputation of complex acoustic environments and use the results to provide more accurate audio playback at runtime, while keeping the runtime compute load acceptably low.

### BRIEF SUMMARY OF THE INVENTION

In one embodiment of the invention a method for optimizing performance of programs requiring spatial audio installed on a computing appliance is provided, comprising steps of (a) loading data representing a digital environment either into a third-party or a stand-alone program; (b) establishing a matrix of one or more nodes located in the virtual space; (c) executing a process by a Central Processing Unit (CPU) of the computing appliance to generate simulated sound waves at a first node; (d) recording the simulated sound properties (given the environment and obstacles that exist in the scene) at that node and at each subsequent node; (e) creating a transfer function matrix including the sound properties as measured by each node; (f) at runtime using the location of the audio source in relation to the nearest simulation nodes to create virtual source node location; (g) at runtime using a listener's position in relation to the nearest simulation nodes to create a virtual listening node; (h) using the virtual source node, virtual listener node, and transfer function matrix to create a unique source-listener transfer function at any location and point in time; (i) applying the resulting transfer function to the audio stream to recreate accurate spatial sound at runtime with low computational overhead.

Also, in one embodiment, the simulation is executed and the transfer functions applied without the need for additional user input. Further in one embodiment the simulation is executed on a remote server and the transfer functions created and returned for use at runtime.

In some embodiments, the user is presented an interactive interface with interactive indicia to configure the computing appliance for optimization of the simulation and resulting transfer functions.

### BRIEF DESCRIPTION OF THE SEVERAL VIEWS OF THE DRAWINGS

FIG. 1 is an illustration of a typical 3D virtual environment where sound does not interact with the environment in a realistic manner.

FIG. 2 is an illustration of a typical layout of nodes to be used in pre-calculating sound characteristics for use at runtime.

FIG. 3 is a flowchart describing one method of cycling through simulation nodes in order to create a matrix of transfer functions to be used at runtime.

FIG. 4 is an example of a table containing an organized matrix of transfer functions.

FIG. 5 is an illustration of a typical layout of nodes that are used at runtime to generate weighted, location-based transfer functions to dynamic sounds and dynamic listeners at runtime.

FIG. 6 shows various distance relationships between sources, listeners, and nodes.

### DETAILED DESCRIPTION OF THE INVENTION

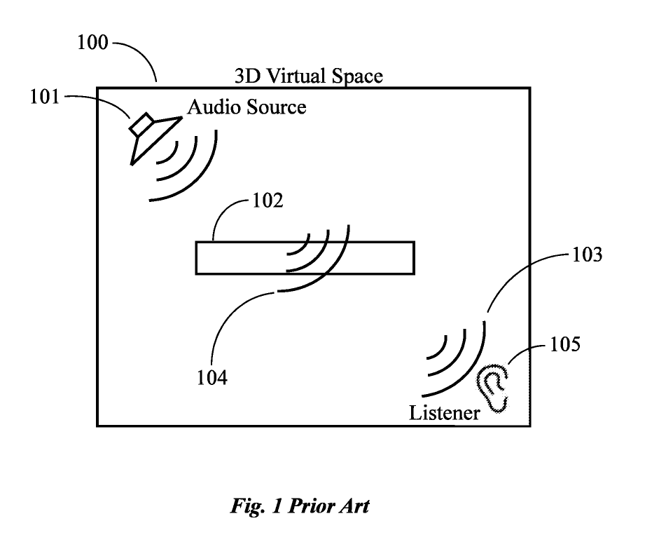

FIG. 1 is an illustration of a typical virtual space 100 with an audio source 101 and a listener 105. In this example of the prior art, the sound 104 does not interact with the environment, which might contain various obstacles 102 which would normally occlude or otherwise effect the sound received 103 at the listener 105. The result is an unrealistic sound experience for the user.

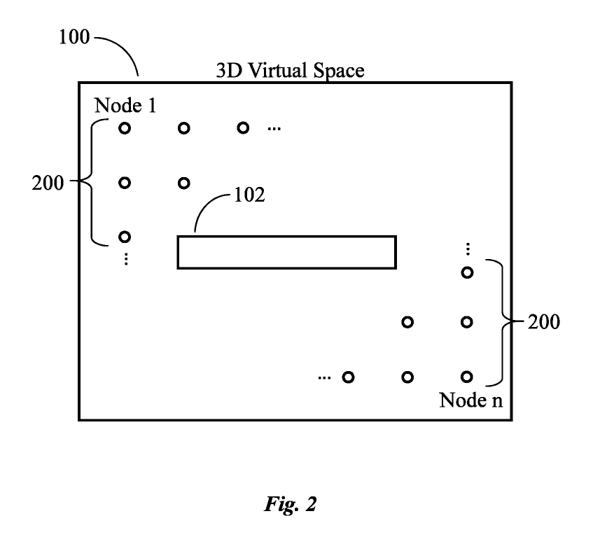

FIG. 2 is an illustration of a typical 3D virtual space 100 with an array of simulation nodes 200 spaced out at some interval that may or may not be linear. Nodes 200 are simply coordinates in the 3D space. Nodes 200 are typically not placed “inside” of solid 3D objects 102 that may exist in 3D virtual space 100 as it is unlikely for a listener to be located inside of a solid object. For the purposes of this illustration, the nodes 200 are spaced at regular intervals in the 3D virtual space 100. Since the array of nodes 200 represent discrete points, sound simulations can be greatly simplified by simulating the sound characteristics at the finite number of nodes versus every possible point in the 3D space 100. Increasing the total number of nodes 200 will increase the fidelity of the results, but comes at an added computational cost. Varying the number of nodes 200 is a good way to tune the system for each 3D virtual space 100 and desired simulation and runtime performance. It should be obvious to one skilled in the art that there are many possible ways to manually or automatically set up the array of nodes 200.

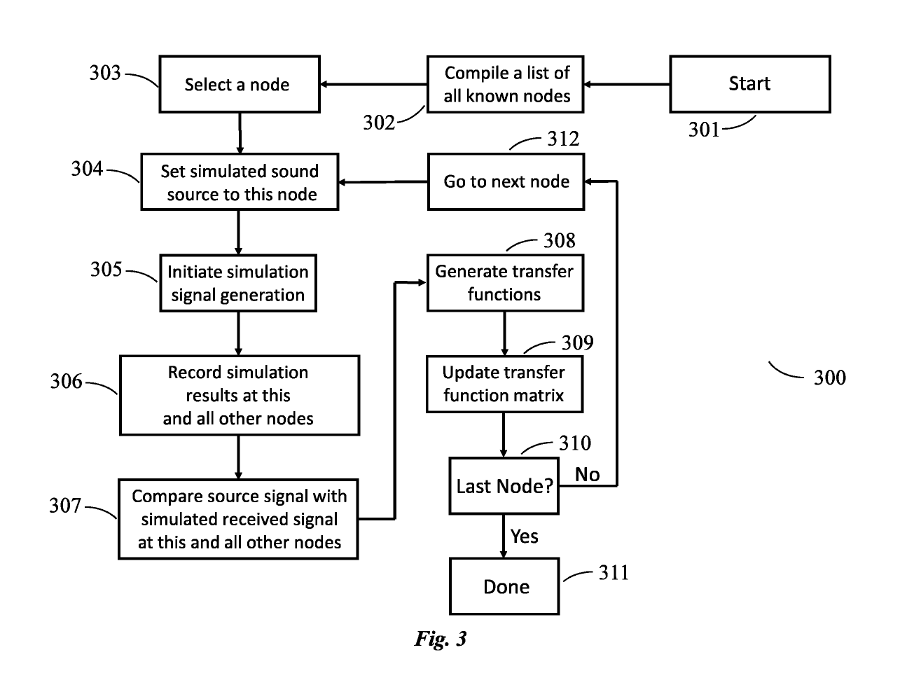

FIG. 3 is a flowchart 300 describing one method of cycling through simulation nodes in order to create a matrix of transfer functions to be used at runtime. In one embodiment a machine-readable media contains instructions to be executed by a CPU (not shown) starting at step 301. At step 302 a list of all known nodes is created, or otherwise imported. At step 303 one of the nodes is selected. Then the process sets the simulated sound source to the current node in step 304. At step 305 a simulated sound source is located at the current node location and a known audio source signal (typically either a swept-frequency sine wave or impulse) is “played”. The resulting simulated sound characteristics are then recorded at this and all other nodes in step 306. In a larger space, it may be desirable to evaluate the results only at nodes within some reasonable sound range of the current node. In step 307 the source signal is compared to the simulated received signal at the current node and all other nodes. From this information a frequency domain transfer function for each node (or node-pair) can be generated at step 308 using one of several common methods known to those with skill in the art. At step 309 each node-pair transfer function is entered into a matrix and given a unique identifier indicating from which nodes the transfer function is derived. If the current node is the last node, step 310 will evaluate true and the process will end at step 311. If the current node is not the last node, the process will move on to step 312 where the next available node is selected. The process then resumes at step 304.

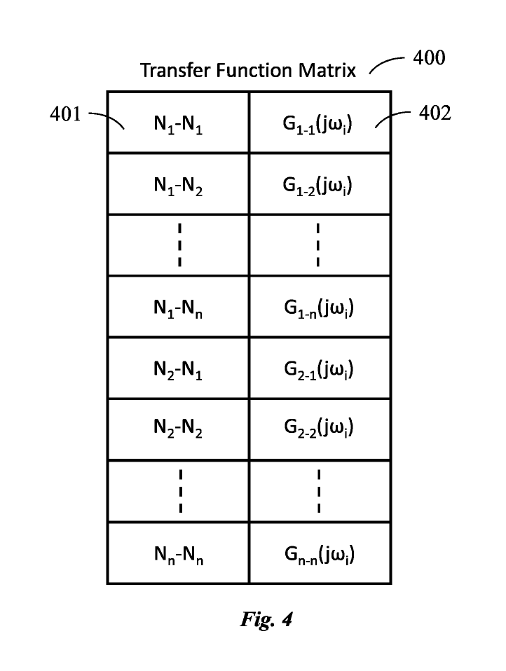

FIG. 4 is an example of a transfer function matrix 400 that contains the transfer functions generated in the process described in FIG. 3. In one embodiment, the transfer function matrix contains an index 401 which may include location information uniquely identifying an associated frequency domain transfer function 402. The transfer functions 402 are shown as Gₓ₋ₓ(jωᵢ) where i=1, 2, 3 . . . representing discrete frequency response characteristics as simulated and measured at the corresponding node pair index 401. It should be obvious to one skilled in the art that there are many common methods to derive, represent and process frequency domain transfer functions and that the symbology 402 used to indicate a transfer function is just one such method.

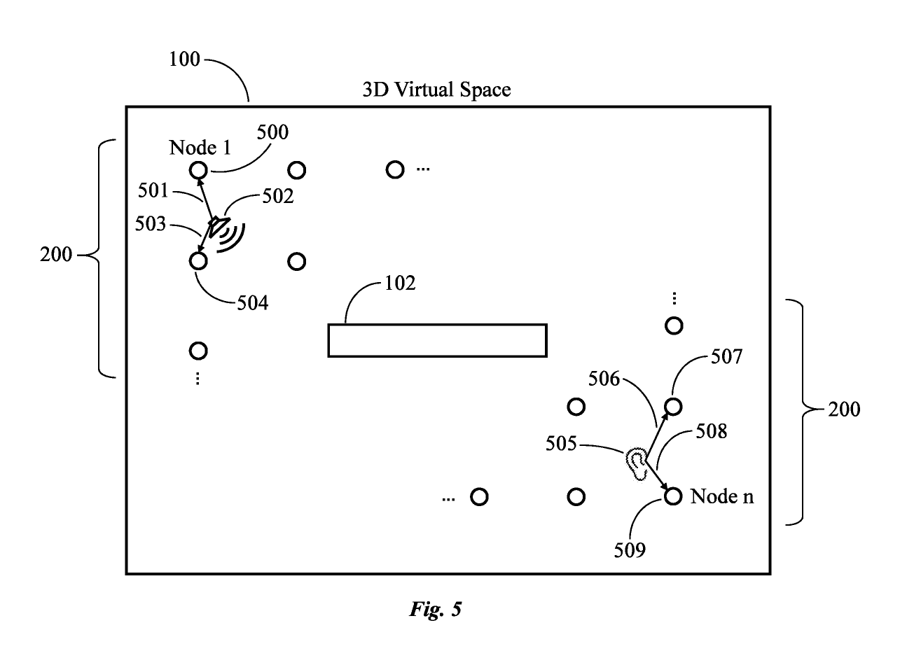

FIG. 5 represents a runtime example of a 3D virtual space 100 populated with nodes 200 at some interval. The 3D virtual space 100 contains one or more objects or features 102 which would normally interact with sound waves in reality. In the 3D virtual space 100 there is also a sound source 502 which is generating some sound at runtime. The 3D virtual space 100 also has a listener 505 at runtime, which is commonly the location of the player, user, or camera. In this embodiment, sound source 502 is located at some distance 501, 503 from the nearest nodes 500, 504. The listener 505 is also located at some distance 506, 508 from its nearest nodes 507, 509. Based on the instantaneous locations of the audio source 502, nearby nodes 500, 504, the listener 505, and its nearby nodes 507, 509, and the previously generated transfer function matrix 400 from FIG. 4, a weighted, blended transfer function can be derived and applied approximating the sound characteristics at locations not exactly corresponding to node 200 locations. For example, at audio source 502, the distance 503 to node 504 is shorter than the distance 501 to node 500 and node 509 is closer to the listener 505 than node 507, therefore the node-504-to-node-509 transfer function would be blended (averaged) with the node-500-to-node-507 transfer function at a higher weight. It should be obvious to one skilled in the art that said weights can be linearly or non-linearly related to the relative distances to the nearby nodes.

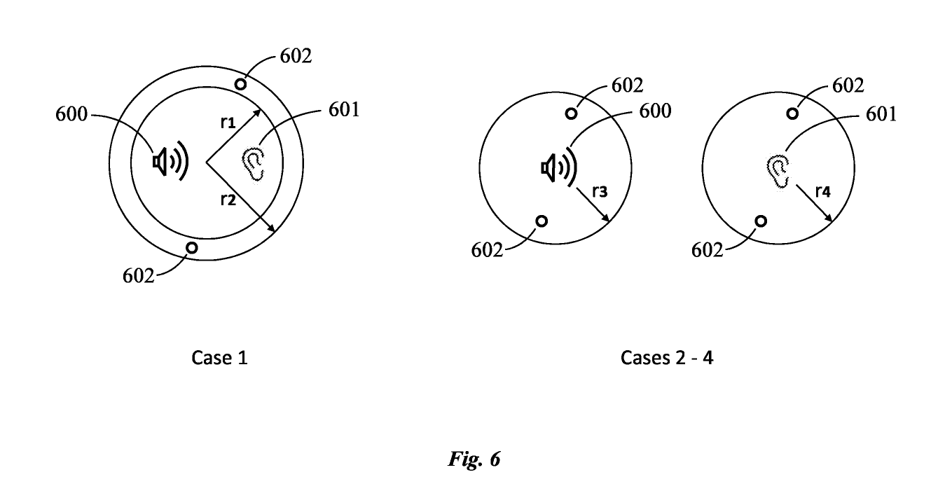

FIG. 6 shows various relationships between audio sources 600, listeners 601, and nodes 602. At runtime, the distances between these come into play when determining which transfer functions to look up and how to assign weights when blending multiple transfer functions.

There are four main cases to consider at runtime, each with 3 subcases. The first case is where the source 600 and the listener 601 are within some radius, r1, of each other. Subcase 1 is where no node 602 is within some radius, r2, of source 600 and listener 601. In this subcase, it is possible to bypass the transfer function matrix 400 of FIG. 4 entirely, since the source 600 and listener 601 are closer to each other than any nodes. The distances r1 and r2 are arbitrary and can vary by use-case and it is possible that r1=r2. Subcase 2 is where there is only one node 602 within some radius, r2, of source 600 and listener 601. In this subcase, it is possible to simply lookup that node's self-transfer function (the transfer function derived from the simulation relating to this node only), since no other nodes are nearby and the source 600 and the listener 601 are close to each other. Subcase 3 is where multiple nodes 602 are within some radius, r2, of the source 600 and the listener 601. In this subcase, the nearest nodes 602 are selected. The number of nearby nodes to select may vary, but for this example, two nodes will be used, as the same principals apply when including additional nearby nodes, however, adding additional nodes is computationally more expensive. The two nodes 602 each have a self-transfer function in the transfer function matrix 400 of FIG. 4. To establish a singular transfer function to use, the self-transfer functions of the nodes 602 are blended (averaged) together, with an optional weight based on the relative distance between each node 602 and the listener 601. These weights can be linear or non-linear.

The second case is where the source 600 and listener 601 are not within some radius, r1, of each other, and there are no nodes 602 within some radius, r3, of the source 600. Subcase 1 is where there are no nodes 602 within some radius, r4, of the listener 601. Since there are no nodes 602 near the source 600 or the listener 601, there is no reference to a transfer function in the transfer function matrix 400 of FIG. 4. In this subcase, a simple, linear, or non-linear, amplitude reduction (based on the distance between the source 600 and the listener 601) can be applied. Subcase 2 is where only one node is within some radius, r4, of the listener 601. In this subcase, there are no nodes near the source 600, but the self-transfer function of node 602 that is close to the listener 601 can be looked up in the transfer function matrix 400 of FIG. 4 and combined with a simple, linear, or non-linear, amplitude reduction, based on the distance between the source 600 and the listener 601. In subcase 3 there are multiple nodes 602 within some radius, r4, of the listener 601. In this subcase, there are no nodes near the source 600, but the self-transfer function of the nodes 602 that are close to the listener 601 can be looked up in the transfer function matrix 400 of FIG. 4, blended (averaged) together, with an optional weight based on the relative distance between each node 602 and the listener 601, and then combined with a simple, linear, or non-linear, amplitude reduction based on the distance from the source 600 and the listener 601.

The third case is where the source 600 and listener 601 are not within some radius, r1, of each other, and the source 600 is within some radius, r3, of only one node 602. Subcase 1 is where there are no nodes 602 within some radius, r4, of the listener 601. Since there are no nodes 602 near the listener 601, there is no reference to a transfer function in the transfer function matrix 400 of FIG. 4. In this subcase, a simple linear or non-linear amplitude reduction based on the distance between the source 600 and the listener 601 can be applied. Subcase 2 is where there is only one node 602 within some radius, r4, of the listener 601. In this Subcase, a straight lookup of the node-to-node transfer function from the transfer function matrix 400 of FIG. 4 can be used. Subcase 3 is where there are multiple nodes 602 within some radius, r4, of the listener 601. In this subcase, the nearest nodes 602 are selected. The number of nearby nodes to select may vary, but for this example, two nodes will be used, as the same principals apply when including additional nearby nodes, however, adding additional nodes is computationally more expensive. The two nodes 602 each have a node-to-node transfer function in the transfer function matrix 400 of FIG. 4. To establish a singular transfer function to use, the node-to-node transfer functions of the nodes 602 are blended (averaged) together, with an optional weight based on the relative distance between each node 602 and the listener 601. These weights can be linear or non-linear.

The fourth case is where the source 600 and listener 601 are not within some radius, r1, of each other, and there are multiple nodes 602 within some radius, r3, of the source 600. Subcase 1 is where there are no nodes 602 within some radius, r4, of the listener 601. Since there are no nodes 602 near the listener 601, there is no reference to a transfer function in the transfer function matrix 400 of FIG. 4. In this subcase, a simple, linear or non-linear amplitude reduction (based on the distance between the source 600 and the listener 601) can be applied. Subcase 2 is where only one node 602 is within some radius, r4, of listener. Since there are multiple nodes 602 near the source 600 in this case, multiple node-to-node transfer functions can be looked up in the transfer function matrix 400 of FIG. 4. To establish a singular transfer function to use, the node-to-node transfer functions of the nodes 602 are blended (averaged) together, with an optional weight based on the relative distance between each node 602 and the source 600. These weights can be linear or non-linear. Subcase 3 is where there are multiple nodes 602 within some radius, r4, of the listener 601. Since this case/subcase has multiple nodes 602 close to both the source 600 and the listener 601, multiple node-to-node transfer functions can be looked up in the transfer function matrix 400 of FIG. 4. To establish a singular transfer function to use, the node-to-node transfer functions of the nodes 602 are blended (averaged) together, with an optional weight based on the relative distance between each node 602, the source 600, and the listener 601. These weights can be linear or non-linear.

The invention claimed is:

1. A system comprising: a first computerized appliance, a processor, at least one persistent memory data repository coupled thereto, and software (SW) executing on the processor from a non-transitory medium, the SW providing a process: creating a virtual grid of simulation nodes within a provided virtual 3D environment, running a test input sound at each node and recording the simulated sound after interacting with the virtual environment for that node and for each subsequent node.

2. The system of claim 1 wherein the simulation results are compared to the simulated input data, allowing a unique transfer function to be generated at and between each node.

3. The system of claim 2 wherein the series of transfer functions unique to each node and node-to-node location are indexed and recorded into a transfer function matrix.

4. The system of claim 3 wherein the relative distances between the source, listener, and nearby nodes are used at runtime in conjunction with the transfer function matrix to generate singular, instantaneous, weighted transfer functions which are then applied to the audio stream.

5. The system of claim 3 wherein the acoustic simulation is run on a remote server and only the transfer function matrix is returned to the local system for use at runtime.

6. The system of claim 5 wherein the relative distances between the source, listener, and nearby nodes are used at runtime in conjunction with the transfer function matrix to generate singular, instantaneous, weighted transfer functions which are then applied to the audio stream.

7. A method comprising: installing an application to a computerized appliance, comprising of a processor, at least one persistent memory data repository coupled thereto, creating a virtual grid of simulation nodes within a provided virtual 3D environment, running a test input sound at each node and recording the simulated sound after interacting with the virtual environment for that node and for each subsequent node.

8. The method of claim 7 wherein the simulation results are compared to the simulated input data, allowing a unique transfer function to be generated at and between each node.

9. The method of claim 8 wherein the series of transfer functions unique to each node and node-to-node location are indexed and recorded into a transfer function matrix.

10. The method of claim 9 wherein the relative distances between the source, listener, and nearby nodes are used at runtime in conjunction with the transfer function matrix to generate singular, instantaneous, weighted transfer functions which are then applied to the audio stream.

11. The method of claim 9 wherein the acoustic simulation is run on a remote server and only the transfer function matrix is returned to the local system for use at runtime.

12. The method of claim 11 wherein the relative distances between the source, listener, and nearby nodes are used at runtime in conjunction with the transfer function matrix to generate singular, instantaneous, weighted transfer functions which are then applied to the audio stream.
